(19) United States
(12) Patent Application Publication
(10) Pub. No.: US 2009/0319629 A1
(43) Pub. Date: Dec. 24, 2009

(54) SYSTEMS AND METHODS FOR RE-EVALUATNG DATA

(76) Inventors: James Allan de Guerre, San Francisco, CA (US); Philippe Le Rohellec, San Francisco, CA (US); Lev Samuel Kaufman, San Francisco, CA (US); Michal Adam Bujak, San Francisco, CA (US)

Correspondence Address: SCHWEGMAN, LUNDBERG & WOESSNER, P.A., P.O. BOX 2938, MINNEAPOLIS, MN, 55402, US

(21) Appl. No.: 12/489,806

(22) Filed: Jun. 23, 2009

Related U.S. Application Data
(60) Provisional application No. 61/132,887, filed on Jun. 23, 2008.

(51) Int. Cl. G06F 15/16; G06F 17/00

(52) U.S. Cl. 709/206; 726/1

(57) ABSTRACT

A method and a system re-classify a delivered message to permit an action to be taken on the delivered message, based on the re-classification. In an example embodiment, a mail transfer agent may receive a message directed to a mail store and a message classifier may generate a representation of at least a portion of the message and classify the message using a representation of the message and a characteristic associated with the representation. In some example embodiments, the mail transfer agent may deliver the message to a message store, based on the classification of the message. Subsequent to the mail transfer agent delivering the message to the message store, a message re-classifier may access a further characteristic associated with the representation and re-classify the message based on the representation and the second characteristic. In an example embodiment, the mail transfer agent may initiate performance of an operation on the message in the message store, based on the re-classifying of the message.

### CLAIM OF PRIORITY

This application claims the priority benefit of U.S. Provisional Application No. 61/132,887, filed Jun. 23, 2008, which is incorporated herein by reference.

### TECHNICAL FIELD

The subject matter relates to the field of digital communication systems. More specifically, but not by way of limitation, claimed subject matter discloses techniques for re-evaluating data that may be communicated over a network.

### BACKGROUND

Modern telecommunication technologies such as the Internet and mobile telephone networks permit people to use methods of communication including email, instant messaging, short messaging service (SMS) text messages, multimedia messaging service (MMS) messages, and a number of other digital messaging communication methods.

Some people, and programs created by people, deliver a flood of unsolicited and/or malicious messages to recipient victims, using the communication methods referred to above. One type of unsolicited message is an unsolicited commercial message, commonly referred to as “spam.” Spam filters have been developed to work with messaging systems in order to filter out unsolicited messages to prevent unsolicited messages or spam from taxing system resources and possibly disturbing message recipients.

### BRIEF DESCRIPTION OF THE DRAWINGS

Some embodiments are illustrated by way of example and not limitation in the figures of the accompanying drawings in which:

FIG. 1 is a block diagram illustrating a data communication network, in accordance with an example embodiment;

FIG. 2 is a block diagram illustrating an example message network including a message server and a mail store, in accordance with an example embodiment;

FIG. 3 is a table illustrating an association between messages and message related values, in accordance with an example embodiment;

FIG. 4 is a table illustrating an association between fingerprints and various fingerprint related values, in accordance with an example embodiment;

FIG. 5. is an interaction flow diagram, illustrating a policy enforcement flow, in accordance with example embodiments;

FIG. 6 is a flow diagram illustrating a method for recording a representation of a message, in accordance with an example embodiment;

FIG. 7 is a flow diagram illustrating an example method for re-evaluating a message, in accordance with an example embodiment; and

FIG. 8 shows a diagrammatic representation of a machine in the example form of a computer system, in accordance with an example embodiment.

### DETAILED DESCRIPTION

Example methods and systems to re-evaluate data are described. In the following description, for purposes of explanation, numerous specific details are set forth in order to provide a thorough understanding of example embodiments. It will be evident, however, to one skilled in the art that the claimed subject matter may be practiced without these specific details.

This detailed description discloses examples of technology that, among other things, permits messages that have been acted upon (e.g., delivered, posted, copied, forwarded, filed, and/or other actions), based on a false, outdated or changed classification, to be identified and re-classified, so as to allow the messages to be acted upon based on an updated classification (e.g., recalled, removed, deleted, re-filed, blocked, and/or other actions). It may be noted that the disclosed techniques may be applied to any classification, and that the example technology may be employed in numerous store-and-forward communication environments.

In one example email environment, a mail server (e.g., a mail transfer agent or a webmail server) may allow an email message in storage to be accessed by a recipient after being informed, by an email filter, that the message was classified as legitimate (hereinafter “legit”). In example embodiments, the email filter may include components (e.g., software and/or hardware components) to determine that the classification of the message as legit was a false positive classification. Email filter components may further notify the mail server that the message should be re-classified from the legit classification to a spam classification. Having been notified that the message is spam, the mail server may initiate an action (e.g., a delete command) that causes the action to be performed (e.g., deletion of the email message), in storage, on the email message. In this manner, a potential recipient of the email message who would normally access the email message from storage may be shielded from receiving spam email.

Messages may be monitored for changes in classification at different occasions during a communication process. For example, in the example email environment above, messages are described as being scanned for changes in classification after a message has been delivered to a mail store but before a message recipient has accessed and/or read the message. Alternatively or additionally, scans for changes in message classification may be made upon a message recipient's log-in to a mail server (e.g., a mail store login) and/or whenever a user specifically requests that the messages be scanned.

Through the practice of example embodiments disclosed herein, an accuracy level associated with data classification may be relatively increased. Consequently, when a policy to be enforced on data is based on data classification, effectiveness of the policy may be relatively improved.

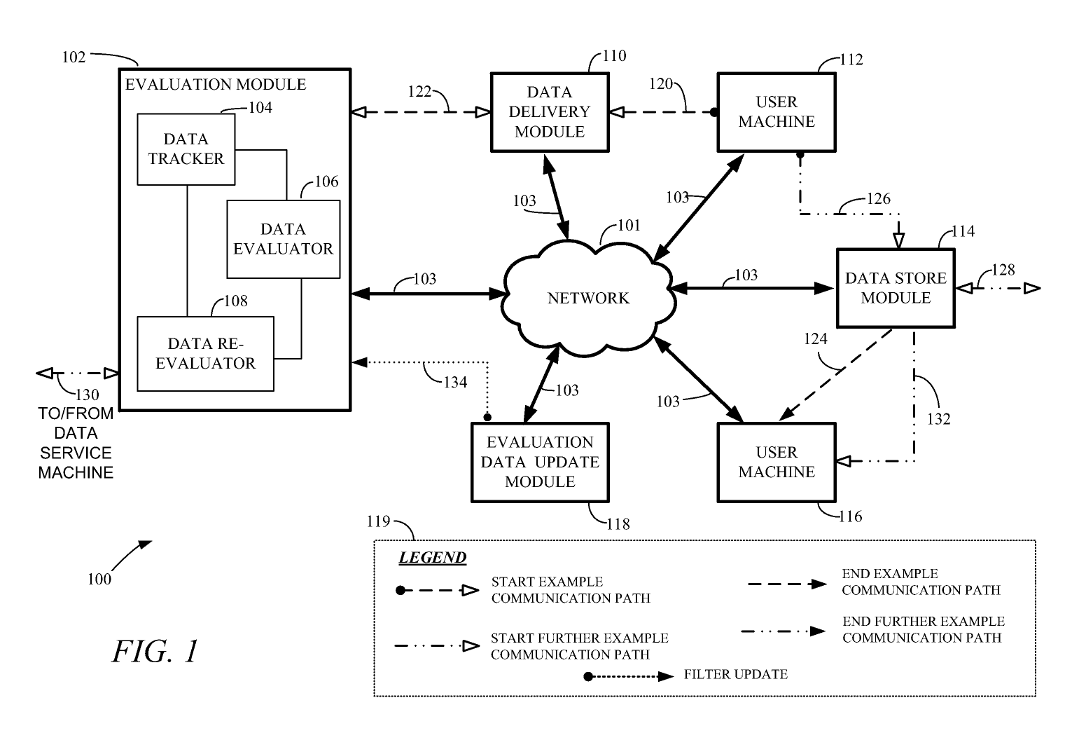

FIG. 1 is a block diagram illustrating a data communication network 100, in accordance with an example embodiment. The data communication network 100 may support communication of digital data between network nodes, and may further support enforcing a data delivery policy before and/or after receipt of the data by a node.

The data communication network 100 is shown to include a evaluation module 102, a data delivery module 110, user machines 112 and 116, a data store module 114, and a evaluation data update module 118, which are coupled with one another via transmission media 103 and a network 101.

For the purposes of this disclosure, communication includes communication of data from a source to a target. The communication of data may include, and be referred to herein, as communicating some or all of a message and/or multiple messages. A message may include an object of communication.

In example embodiments, a message may include, but not be limited to, an email, an instant message, short message service (SMS) message, a multi-media service (MMS) message, Web page content (e.g., a blog post or webmail), user generated content messages, a voicemail message, a video message, a graphics message, or any other digital object of communication.

Sources and/or targets of communication may be associated with a user. As used herein, a user may include a human use of a user machine, hardware such as circuitry, instructions such as software, and/or a combination of hardware and instructions.

The user machines 112 and 116 may include any networked machine or device that transmits and/or receives data (e.g., messages) via the network 101. Although the user machines 112 and 116 may include any networked device, some example network devices may include one or more of a desktop computer, a mobile device, a server, a mass storage device, or any other machine.

The example data delivery module 110 is to receive data, enforce a delivery policy upon the data, and deliver the data to a target, if the delivery policy permits. In some example embodiments, the data delivery policy may permit the data delivery module 110 to route a received message to the data store module 114, where the message may be made accessible to a recipient such as a user of the user machine 116. Alternatively or additionally, the data delivery module 110 may route a received message to the user machine 116, where a recipient user of the machine may access the message. It may be noted that the types of messages that the data delivery module 110 receives and delivers may include, but not be limited to, any of the example message types referred to above.

FIG. 1 is shown to include a legend 119 related to communication between networked machines and/or modules. The arrows 120, 122, 126, 128, 130, and 132, and 134, represent an example high level path of communication and do not necessarily represent direct paths between networked components. For example, communication may be navigated through intermediate networked components that are not shown in FIG. 1.

In an example flow of communication, a message directed to a recipient at the user machine 116, by a sender at the user machine 112, may first be received by the data delivery module 110, as indicated by the arrow 120. The message may be forwarded to the evaluation module 102 for evaluation, as indicated by the arrows 122, and then may be stored in the data store module 114, as indicated by the arrow 124, only if the data delivery module 110 determines, with certain information provided by the evaluation module 102, as indicated by the arrows 122, that the message should be allowed to reach the user machine 116.

The data store module 114 is to receive data, store the data, perform operations on the data, and allow access to the data.

In an example embodiment, the data store module 114 may be run or operated by a desktop computer and a user of the desktop computer may access email messages stored by the data store module 114, via a message viewing application run by the desktop computer.

In some example embodiments, the data store module 114 may be used as a remote mail store (e.g. remote to a message recipient) that makes messages available to be accessed by a recipient, over the network 101, via a message viewing application operating on the user machine 116.

Alternatively or additionally, the data store module 114 may be operated by a Web server that serves Web pages to a browser operating on the user machine 116. A Web page served to the browser may include one or more webmail messages directed to a user of the user machine 116. In some example embodiments, a Web page served to the browser may include user-generated content such as a blog entry or wall posting (e.g., posted to a social networking page) that includes one or more messages directed to the user of the user machine 116.

In a further example flow of communication, a message directed to a recipient at the user machine 116 by a sender at user machine 112 is stored in the data store module 114, as indicated by the arrow 126. The message may be forwarded to the evaluation module 102 for evaluation, as indicated by the arrows 128 and 130. The stored message may be accessed by the intended recipient, as indicated by the arrow 132, only if the data store module 114 has determined, with certain information provided by the evaluation module 102 as indicated by the arrows 128 and 130, that the message should be allowed to be accessed by the recipient at the user machine 116.

The evaluation module 102 is shown to include a data evaluator 106, a data tracker 104, and a data re-evaluator 108. The functionality of the data evaluator 106, the data tracker 104, and the data re-evaluator 108 are discussed in further detail below.

The evaluation module 102, as introduced above, is to receive data (e.g., a message or messages) from a sender and provide information about the data that may be used (e.g., by the data delivery module 110 or the data store module 114) to determine whether or not the data should be allowed to reach an intended recipient. In various example embodiments, the evaluation module 102 may employ the data evaluator 106 to evaluate the data prior to the message being made available to a recipient; and may further employ the data tracker 104 and data re-evaluator 108 to re-evaluate the data subsequent to the data being made available (e.g., a message may be available once delivered to a data store or to a user machine) to the recipient.

It may be noted that one or more machines may fully or partially implement the evaluation module 102 together with the data delivery module 110. For example, the one or more machines operating the data delivery module 110 may provide some or all of the functionality of the data tracker 104, the data evaluator 106, and/or the data re-evaluator 108. Alternatively or additionally, one or more machines may fully or partially implement the evaluation module 102 together with the data store module 114.

It may further be noted that, the data tracker 104, the data evaluator 106, and the data re-evaluator 108 may not all be implemented by the same machine. For example, the data evaluator 106 may be implemented by a machine or machines with the data delivery module 110 and the data tracker 104 and/or data re-evaluator 108 may be implemented by a different machine or machines with the data store module 114. Of course, a person having ordinary skill in the art will recognize that numerous other configurations may be employed without departing from the scope of the claimed subject matter.

The data evaluator 106, shown within the evaluation module 102, is to receive data, and obtain from the received data information related to the nature of the data that may be used to decide how to treat the data. In an example embodiment, in furtherance of classifying a received message, the data evaluator 106 may use information obtained from the message (e.g. message content) to represent the message. Representation of a message may be based on all content in the message, a portion of the content in the message, or multiple portions of the content in the message. The representations of the message may subsequently be used to classify the message.

An example representation of a message may include data (e.g., a character string) that is associated with a property or attribute of the message and that may indicate the nature or classification of the message. The representation may be used to represent or stand-in for the full message, which may be stored separately from the representation. Example properties or attributes of a message may include: information in a header of the message, a sender identifier, content in the subject line of the message, certain keywords found in the message, a time the message was sent, and other information that may be extracted from the message or that is associated with the message. A representation of a message may include multiple character strings, each being associated with a different attribute of the message. In various example embodiments described herein, a representation of a message may include a value (e.g., a hash value) that results from processing a portion of the message in an algorithm (e.g., a hash function).

A representation of a message may be associated with known characteristics of messages. A classification of the message may be determined from the known characteristics of the messages. For example, a message that includes the text, “buy now!” and “amazing deals!” (e.g., message attributes) may be represented by the strings “buy now!” and “amazing deals!” respectively, or may be represented by hash values resulting from processing hash function(s) on the text. A characteristic known to be associated with the string “buy now!” and “amazing deals!”, or their respective hash values, may include the characteristic of “offensive ad.” For some example embodiments, a rule enforced by the data evaluator may set forth that a message with the characteristic of “offensive ad” should be classified as “unsolicited message.” In some example embodiments, one characteristic may be given more or less weight than another characteristic in determining the classification of a message. Some message attributes may be associated with new viruses or phishing attempts and such messages may be classified based on that knowledge.

Selection of appropriate message attributes, characteristics, classifications, and the manner in which characteristics determine classifications may depend on an environment in which messages are being filtered. Some communication environments that may employ the message filtering disclosed herein may include, but not be limited to: email systems providing social networking messaging, mobile messaging, text messaging, multi-media messaging, message routing, message proxies, and various other messaging scenarios that involve storing messages and forwarding the messages to a target or recipient.

In some example embodiments, once a message has been initially classified by the evaluation module 102, the message may be cleared for delivery to the recipient (e.g., by the data delivery module 110), based on a message delivery policy. At some time relative to message delivery, the data tracker 104 may record a representation of the message.

The data tracker 104 is to record representations of data. For some example embodiments, the data tracker 104 may record a representation of a message with an associated message identifier in a data structure. In example embodiments in which a message is represented by multiple hash values that are each associated with different characteristics, the data structure may include a message identifier and pointers to multiple corresponding hash values. The data structure may subsequently provide access to the data re-evaluator 108 so that the data re-evaluator 108 may re-evaluate the stored data. The data tracker 104 may manage removal of the representations from the data structure. As discussed in more detail below, some example parameters for removal may include an amount of time a message representation has been stored, an amount of storage space that is being used to store representations, and a number of message representations currently being stored.

The evaluation data update module 118 may, from time to time, update the data evaluator 106 with updates of information used to re-evaluate data. In some example embodiments, the updated information may include message attributes (e.g., hashed attributes or fingerprints) used to represent messages and corresponding characterization data that the data re-evaluator 108 may use to re-evaluate messages.

For example, the evaluation data update module 118 may provide updated characteristics of message attributes that were not previously provided to, or used by, the data evaluator 106 to evaluate messages. The updated information may be based on, for example, collective intelligence of users of the data communication network 100 with regard to message attributes. The updated characteristics may be generated by the evaluation data update module 118 or be provided to the evaluation data update module 118 from a local or remote source. The evaluation data update module 118 need not be dedicated to providing update information and may be operated by any appropriate machine.

The data re-evaluator 108 is to re-evaluate a result of the evaluation performed by the data evaluator and to provide notice of any change in that result.

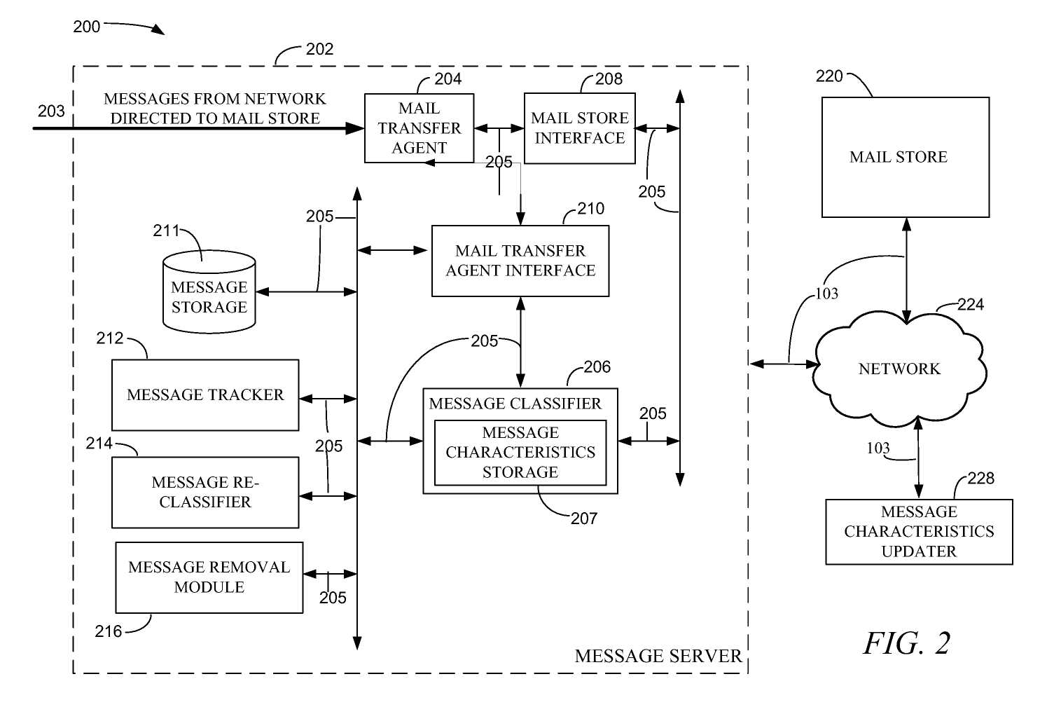

Referring to the example above, the characteristic of “offensive ad” known to be associated with the strings “buy now!” and “amazing deals!” or their respective hash values, may be updated to reflect the characteristic of “respectful ad.” The data re-evaluator 108 may re-evaluate the message based on a change in characteristic (e.g., received from the evaluation data update module 118) and provide notification to the data delivery module 110 that the classification of the message has changed to “neutral ad message” so that the data delivery module 110 may enforce an appropriate message delivery policy. Further example embodiments are discussed with respect to FIGS. 2-7 below.

Referring to FIG. 1, the evaluation module 102, the data tracker 104, the data re-evaluator 108, the data delivery module 110, the data store module 114, and the evaluation data update module 118 may each be implemented as modules. For the purposes of this specification, a module may be implemented using software, hardware/circuitry, or a combination of software and hardware/circuitry. For example, the term “module” may include an identifiable portion of code, computational or executable instructions, data, or computational objects to achieve a particular function, operation, processing, or procedure. A module need not be implemented in software, and in some example embodiments, a module may be implemented using an application-specific integrated circuit (ASIC) or programmable circuitry designed to perform the function and/or functions of the module. A module being implemented using hardware and software may include, but not be limited to, a module that exists during a quantity of time that a processor (e.g., hardware) executes instructions (e.g., software) to perform the function and/or functions of the module.

FIG. 2 is a block diagram illustrating a message network 200 including a mail transfer agent 204 and a mail store 220, in accordance with an example embodiment. FIG. 2 is shown to include a message server 202 coupled to the mail store 220 and coupled to a message characteristics updater 228, via a network 224. The message server 202 is shown to include numerous components coupled with one another via communication channels 205. Each of the components is discussed in turn below.

The mail transfer agent 204 is to receive messages 203 directed to a recipient and transfer at least some of the messages to the mail store 220 via the network 224. A message classifier 206, which is discussed in more detail below, may provide a message classification that may be used to enforce a message policy to block some of the messages that would otherwise be transferred by the mail transfer agent 204 to the mail store 220.

In various example embodiments, the mail transfer agent 204 may issue requests to perform actions on messages that have not been blocked due to a message policy and have already been delivered to the mail store 220. For example, a message that the message classifier 206 previously classified, for example, as “acceptable” prior to the time the message was delivered to the mail store 220, may later be deleted (e.g. by the request of the mail transfer agent 204) from a location in the mail store 220 subsequent to the message re-classifier 214 changing the classification of the message, for example, to “unacceptable.”

The message classifier 206 is to classify messages received by the mail transfer agent 204. In an example embodiment, the message classifier 206 operates a fingerprint algorithm on a selection of data (e.g. or multiple selections) from a received message to generate a representation of that selection. In some example embodiments, the selection of data from the message may include a bit stream that is considered an attribute of the message. The fingerprint algorithm may reduce the message attribute to a relatively smaller bit stream that uniquely identifies the bit stream (e.g., the attribute or the selection of data) from which the fingerprint was derived.

In an example embodiment, the message classifier 206 may perform a subsequent comparison between an unknown fingerprint, such as a fingerprint of an attribute of a received message, and a characterized fingerprint. If the characterized fingerprint matches the unknown fingerprint, then the unknown fingerprint, and consequently the attribute of the received message, may share a characteristic with the characterized fingerprint. If the comparison yields no match, then a characteristic may not be associated with the unknown fingerprint.

The message classifier 206 may include a message characteristics storage 207 to store the library of representations, and corresponding known characteristics (e.g. transparent libraries). In some example embodiments, a library of previously generated representations of message content (e.g., commonly occurring keywords) and associated characteristics may be referenced by the data evaluator 106 of FIG. 1 to identify a characteristic of a received message.

A fingerprint may be taken of the phrase “great deals!” and then the fingerprint may be characterized as a spam indicator. The characterized fingerprint may then be stored in the message characteristics storage 207 for later reference.

The message characteristics updater 228 is to provide updates to the message classifier 206 (e.g., to the message characteristics storage 207) with fingerprints and corresponding characteristics of the fingerprints. Updates may be requested by the message classifier 206 and/or the message characteristics updater 228 may provide the updates automatically. In an example embodiment, each fingerprint may be associated with a single characteristic but in some example embodiments, each fingerprint may be associated with multiple characteristics. For some example embodiments, the message characteristics updater 228 provides an update to the message characteristics storage 207 of the message classifier 206 every 30 to 60 seconds; however, the updates may be provided based on any appropriate input.

The mail store interface 208 may provide an interface for communication between the mail transfer agent 204 and the mail store 220. In various example embodiments, the mail transfer agent 204 enforces mail policy on a message in the mail store 220 through the mail store interface 208, which may facilitate action on designated messages stored by the mail store 220. For some example embodiments, the mail store interface 208 initiates a specific action to be taken on a message (e.g., deletion at the message or movement of the message to a spam folder) by transferring an application program interface call to the mail store 220. In an example embodiment, the mail store interface 208 integrates with Web services of the mail store 220 using the application programming interface (e.g., simple object access protocol (SOAP)) of the mail store 220s.

The mail transfer agent interface 210 is to facilitate communication between the mail transfer agent 204 and various other system components including the message characteristics storage 207, the message classifier 206, the message tracker 212 and the message re-classifier 214. As introduced above, the mail transfer agent interface 210 may notify the mail transfer agent 204 when a characteristic of message has changed.

The message tracker 212 is to update the message storage 211 with appropriate records, in some example embodiments, for each message delivered to the mail store 220 by the mail transfer agent 204. In an example embodiment, the message tracker 212 may receive a notification from the message classifier 206, via the mail transfer agent interface 210 when a message is to be delivered to the mail store 220, and responsive to the notification, update the message storage 211 with information about each such message (e.g., a message identifier and a message representation). The mail transfer agent 204 may specify, via the mail transfer agent interface 210, the message information to be stored in the message storage 211 by the message tracker 212. For example, the specific information may include a message identifier, recipient address, and a timestamp indicating a time that the message was delivered.

The message storage 211 may store a data structure to keep a record of message representations, such as fingerprints, for the messages that have been delivered to the mail store 220. The message storage 211 may be accessible by the message tracker 212, the message re-classifier 214, and the message removal module 216. In some example embodiments, the message storage 211 is implemented as an in-memory database; however, other appropriate data structures may be employed.

The message re-classifier 214 is to determine whether an updated characteristic of a message results in re-classification of the message. For example, a representation of a message may include three fingerprints, each associated with a characteristic, and when a characteristic of one of the fingerprints changes, the message re-classifier 214 may determine that the classification of a message also changes. The message re-classifier 214 may request a notification from the message classifier 206 of any updates received by the message characteristics storage 207 from the message attributes updater 228. In an example embodiment, the message re-classifier 214 may notify the mail transfer agent 204 of a change in classification of a message that the mail transfer agent 204 has already delivered to the mail store. Example embodiments describing re-classification of messages are discussed in further detail below.

The message removal module 216 is to periodically and/or occasionally remove records from the message storage 211. In an example embodiment, the more time that a message representation is stored, the more likely it is that the corresponding message will be correctly classified. Some message representations may be given more weight than others when making the determination of classification so in some cases, it may be appropriate to store some message representations longer than other message representations. In an example embodiment, to provide an appropriate interval of removal, the message removal module 216 may age out one message representation after 60 minutes has expired since the message representation has been stored but not age out another message representation unless the other message representation has been stored for more than 90 minutes. In an example embodiment, the default configuration of the interval for aging is an expiration of 60 minutes but a custom interval of removal may be designated based in part or based entirely on availability of system resources.

The mail store 220 may include storage for messages that is made accessible to recipients of the messages. In various example embodiments, the storage may include a data structure accessible by a machine, a machine's internal memory (e.g., random access memory), and/or storage that is external to machine (e.g., a hard disk or an array of hard disks). The mail store 220 may provide an interface to allow communication related to re-classification of messages stored at storage locations in the mail store 220. In some example embodiments, a machine may be coupled to the mail store 220 to perform various operations on messages in the mail store 220 responsive to instructions from the mail transfer agent 204.

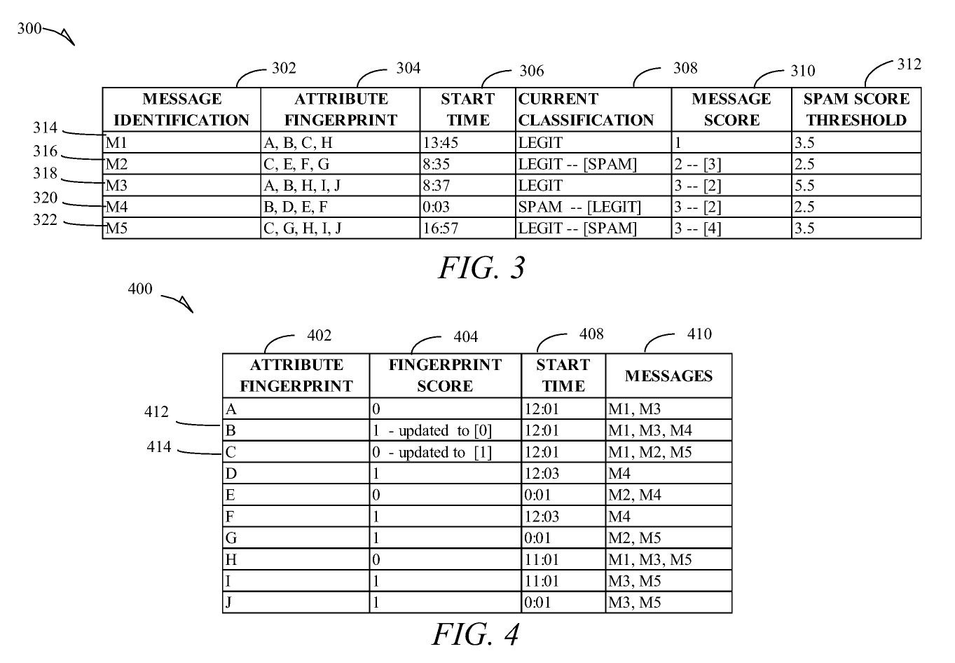

FIG. 3 is a table 300 illustrating an association between messages and message related values, in accordance with an example embodiment. In example embodiments, the message tracker 212 of FIG. 2 may store, in the message storage 211, a data structure including the values shown in the table 300. The message re-classifier 214 and message removal module 216 of FIG. 2 may access the values shown in table 300 during the course of providing their respective functionalities. The table 300 is shown to include a message identifier column 302, an attribute fingerprint column 304, a timestamp column 306, a current classification column 308, a message score in message score column 310, and a spam score threshold column 312.

The message identifier column 302, in each intersecting row 314, 316, 318, 320, and 322, shows a message identifier representing each message delivered to the mail store 220 of FIG. 2. For example, the message identifier “M1” in the first row 314 of message identifier column 302 corresponds to a particular message, and the message is identifiable by the message identifier “M1.”

The attribute fingerprint column 304, in each intersecting row 314, 316, 318, 320, and 322, shows characters representing fingerprints of message attributes associated with each message delivered to the mail store 220. For example, each of the characters A, B, C, H of attribute fingerprint column 304, row 314, may represent different hash values. In an example embodiment, each attribute fingerprint value shown in the table 300 represents a pointer to an address in storage that includes the actual fingerprint.

The timestamp column 306, in each intersecting row 314, 316, 318, 320, and 322, shows a time that a message was first stored in the mail store 220 of FIG. 2. In an example embodiment, the fields of the timestamp column 306 may be accessed at different times by the message removal module 216 of FIG. 2 as part of aging out certain values in the message table 300 (described in further detail below).

The current classification column 308 of the table 300, in each intersecting row 314, 316, 318, 320, and 322, shows a message classification at a time that each corresponding message was delivered to the mail store 220 of FIG. 2. For example, row 316 is shown to include a current classification of legit, while row 320 shows a current classification of spam. The square bracketed values in the current classification column 308 and the message score column 310 represent values that result from a fingerprint update and are discussed further below.

The message score column 310, in each intersecting row 314, 316, 318, 320, and 322, shows a message score associated with each corresponding message delivered to the mail store 220 of FIG. 2. In an example embodiment, a message score is a sum of fingerprint scores corresponding to each fingerprint representing a message. Fingerprint scores are discussed further with respect to FIG. 4.

The spam score threshold column 312, in each intersecting row 314, 316, 318, 320, and 322, shows a spam threshold score. In an example embodiment, if a message score in the message score column 310 exceeds the spam threshold score in spam score threshold column 312, the message may be considered spam. For example, in row 320 message score is shown to be “3” which exceeds the spam score threshold, which is shown to be “2.5,” resulting in a current classification of spam for the message represented by the message identifier M4.

FIG. 4 is a table illustrating an association between fingerprints and various fingerprint related values, in accordance with an example embodiment. The values shown in table 400 of FIG. 4 may be stored by the message classifier 206 of FIG. 2.

The attribute fingerprint column 402, in each intersecting row, shows a letter representing a fingerprint of a message attribute. For example, in row 412, a fingerprint represented by the letter “B” is associated with messages M1, M3, and M4 of the messages column 410.

The fingerprint score column 404, in each intersecting row, is shown to include a value or score associated with each respective attribute fingerprint. The example fingerprint values are shown to be either “0” or “1,” indicating that an attribute fingerprint may have one of two possible characteristics. For example, the number “1” may represent that the message attribute is associated with spam messages and the number “0” may represent that the message attribute is associated with legit messages; however, a reverse relationship may be used. In one example embodiment, the attribute fingerprint “C” in row 414 of the attribute fingerprint column 402 is associated with legit messages because a “0” appears in the corresponding fingerprint score column 404.

The timestamp column 408, in each intersecting row, is shown to include a time the attribute fingerprint was stored for the purpose of characterizing messages. Like the timestamps in column 306 of FIG. 3, the timestamps of FIG. 4 may be used for aging out values and, in this example embodiment, to age out attribute fingerprints.

The messages column 410, in each intersecting row, is shown to include a message having the attribute that was fingerprinted and shown in the attribute fingerprint column 402. For example, for row 412, the attribute fingerprint “B” represents an attribute included in the messages that are represented by the identifiers M1, M3, and M4.

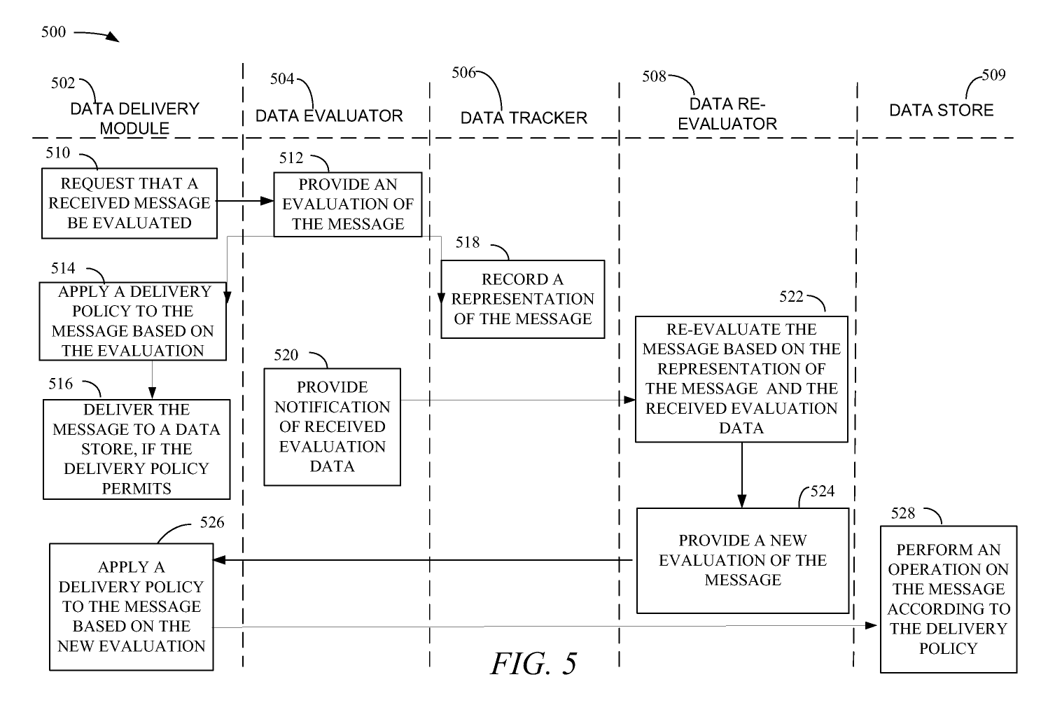

FIG. 5. is an interaction flow diagram 500, illustrating an example policy enforcement flow, in accordance with example embodiments. The interaction flow diagram 500 is shown to include: a data delivery module column 502 including operations that may be performed by the data delivery module 110 of FIG. 1 and the mail transfer agent 204 of FIG. 2; a data evaluator column 504 including operations that may be performed by the data evaluator 106 and the message classifier 206 of FIG. 2; a data tracker column 506 including an operation that may be performed by the data tracker 104 and the message tracker 212 of FIG. 2; a data re-evaluator column 508 including operations that may be performed by the data re-evaluator 108 of FIG. 1 and the message re-classifier 214 FIG. 2; and a data store column 509 including an operation that may be performed by the data store module 114 of FIG. 1 and the mail store 220 of FIG. 2.

At block 510, the flow 500 may include a data delivery module requesting that a received message be evaluated. Referring to FIG. 2, messages 203 are shown to be received by the mail transfer agent 204. The mail transfer agent 204 may receive one such message and communicate with mail transfer agent interface 210 to request that the message classifier 206 score or classify the message.

At block 512, the flow 500 may include a data evaluator providing an evaluation of the message. In an example embodiment, providing an evaluation may include generating a message representation including, for example, a hash value or fingerprint of a portion of the message. Providing the representation may further include accessing a characteristic associated with the representation. For example, for the received message, the message classifier 206 of FIG. 2 may generate a fingerprint of an attribute of the message to represent the message. The message classifier 206 may use the fingerprint to identify, in the message characteristics storage 207 of FIG. 2, a characteristic or score known to be associated with the fingerprint.

In some example embodiments, the message classifier 206 of FIG. 2 may calculate a message score and determine whether the scored message indicates a spam or legit message. However, message scores may be assigned to classifications other than spam or legit. At block 514, the flow 500 may include a data delivery module applying a delivery policy to a message based on the evaluation. In some embodiments, the mail transfer agent 204 of FIG. 2 may determine whether the message is spam or legit depending on a spam policy associated with the recipient of the message. Alternatively or additionally, some message delivery policies may be determined, in full or in part, on a message by message basis.

At block 516, the example flow 500 may include a data delivery module delivering a classified message to a data store, if the delivery policy permits. Referring to FIG. 2, the mail transfer agent 204 may deliver the example message to the mail store 220 if the message is determined to be legit or may block the example message from reaching the mail store 220 if the message is determined to be a spam message. It may be noted that messages other than legit messages may be delivered to the mail store 220. For example, messages of any classification may be delivered to the mail store 220, if doing so accords with the message delivery policy.

At block 518, the example flow 500 may include a data tracker recording a representation of the message. The recording at block 518 may be preceded by the message tracker 212 of FIG. 2 receiving a notification that the fingerprint or fingerprints of the message should be recorded. For some example embodiments, the indication and values to be recorded (e.g., the message identifier, associated message fingerprints, other values described with respect to FIG. 3, or any other appropriate values) may be provided by the mail transfer agent interface 210 of FIG. 2.

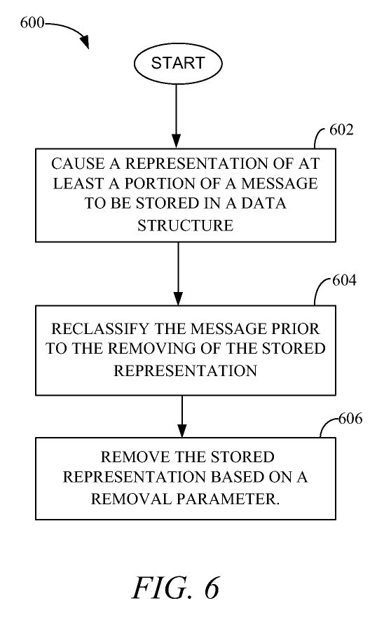

Attention is briefly directed to FIG. 6. FIG. 6 is a flow diagram illustrating a method 600 for recording a representation of a message, in accordance with an example embodiment. At block 602, the example method 600 may include causing a representation of at least a portion of a message to be stored in a data structure.

In some example embodiments, data structures stored by the message storage 211 of FIG. 2 may include a linked list of messages in which each message may be associated with a list of pointers to corresponding signatures (e.g., hashed message attributes). The message storage 211 may also include a hash table of signatures in which each signature is associated with a list of pointers to messages represented by each signature.

For example, in response to notification from the mail transfer agent interface 210 of FIG. 2, the message tracker 212 may append a message identifier, such as M1 in row 314 of FIG. 3, to a linked list of messages. For each signature associated with each message (e.g., attribute fingerprints A, B, C, and H of row 314 of FIG. 3), if the signature is in the hash table of signatures already (e.g., the attribute fingerprint column 402 of FIG. 4), the message tracker 212 may add a pointer to the new message in the list of pointers to the messages (e.g., the messages column 410 of FIG. 4) in the hash table of signatures. If the signature is not in the hash table of signatures, the message tracker 212 may add the signature to the hash table of signatures and add a pointer to the message into the list of pointers to the messages for that signature.

At block 604, the example method 600 may include re-classifying the message prior to the removing of the stored representation, and at block 606, removing the stored representation based on a removal parameter. In example embodiments, the removal parameter may include an interval of time, a maximum memory size to be used to store fingerprints and messages, and/or a maximum number of fingerprints and/or messages that may be stored.

For example, the message removal module 216 of FIG. 2 may access the message storage 211 at the head of the linked list of messages, introduced above, to compare a timestamp in the timestamp column 306 of FIG. 3 to a current time and determine whether a designated interval of time has been exceeded. Alternatively or additionally, the message removal module 216 may determine whether the message storage 211 has exceeded a maximum number of messages or memory space. If the interval and/or the maximum limits have been exceeded, the message removal module 216 may remove the message at the head of the linked list of messages. For each signature associated with a removed message, the message removal module 216 may access the hash table of signatures to disassociate the message from the signature.

Returning to FIG. 5, at block 520, the example flow 500 may include a data evaluator providing notification of received evaluation data. Referring to FIG. 2, the message re-classifier 214 may request, from the mail transfer agent interface 210, to be notified of message characteristic updates made to the message characteristics storage 207. In an example embodiment, when the message characteristics updater 228 makes an update subsequent to the mail transfer agent 204 delivering a message to the mail store 220, the message re-classifier 214 may access an updated characteristic associated with a representation of a message, via the mail transfer agent interface 210, either by automatically receiving the updated characteristics (e.g., resulting from registering the call back) and/or by explicitly requesting updated characteristics.

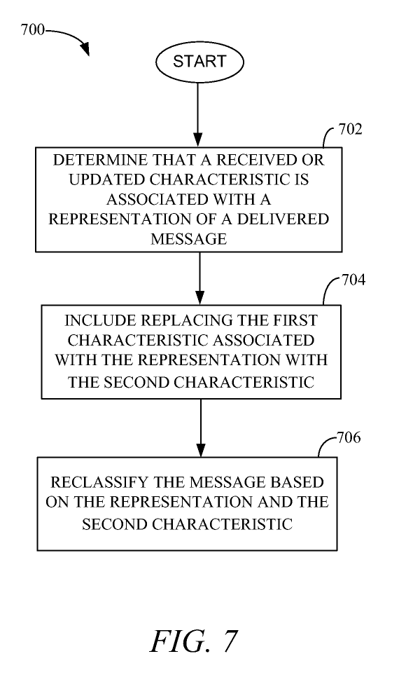

At block 522, the example flow 500 may include a data re-evaluator re-evaluating a message based on a representation of the message and received evaluation data. Re-evaluating the message is now described in a separate flow diagram of FIG. 7.

FIG. 7 is a flow diagram illustrating an example method 700 for re-evaluating a message, in accordance with an example embodiment. At block 702, the example method 700 may include determining that a received or updated characteristic is associated with a representation of a delivered message. As described with regard to FIG. 2, the message re-classifier 214 may obtain an updated representation characteristic (e.g., an updated fingerprint score).

In an example embodiment, a hash table of signatures may include the information shown in table 400 of FIG. 4 and the message re-classifier 214 may access the hash table of signatures to identify any messages that the updated fingerprint may represent. Using the attribute fingerprint “B” of FIG. 4, row 412, as an example of the updated message characteristic, the message re-classifier 214 of FIG. 2 may determine that the attribute fingerprint “B” is associated with the messages M1, M3, and M4 as shown in row 412, messages column 410 of FIG. 4. At block 704, the example method 700 may include replacing the first characteristic associated with the representation with the second characteristic. Continuing with the hash table of fingerprints example, the message re-classifier 214 of FIG. 2 may identify the fingerprint value such as the attribute fingerprint “B” of row 412 and replace an original fingerprint score of “1” with the updated fingerprint score of “0.”

At block 706, the example method 700 may include re-classifying the message based on the representation and the updated characteristic. For example, the re-classifier 214 of FIG. 2 may determine that the replacing of the characteristic changes the classification of the message. In FIG. 3, for each message M1, M3, M4, the message re-classifier 214 of FIG. 2 may recalculate the message score with consideration given to the updated fingerprint score.

Taking the message M2 of row 316 of FIG. 3 for example, it can be seen in row 414, FIG. 4 that the attribute fingerprint “C,” which is associated with the message M2, has been updated to a value of “1” from a value of “0.” Since fingerprints “E,” “F,” and “G,” of row 316, FIG. 3 have unchanged fingerprint scores of “0,” “1,” and “1” respectively, the re-evaluator of FIG. 2 may calculate the updated message score for the message M2 to be “3” as shown (e.g., in brackets) in row 316, message score column 310 of FIG. 3. The example message re-classifier 214 may compare the new message score of “3” in message score column 310 to the spam threshold score of “2.5” shown in row 316, spam score threshold column 312. A change in classification is described in the following example embodiment.

The example message re-classifier 214 of FIG. 2 may determine by accessing a data structure that the message M2 was initially classified as legit, as is the case for the example message M2, in row 316, message score column 310. For the message M2, the current classification of legit may be considered to be a false positive because the new message score of “3” exceeds the spam threshold for the message M2. As discussed below with respect to block 524, action may be taken on the message based on the change in classification of the message M2 from legit to spam.

Referring again to FIG. 4, the example fingerprint score of the attribute fingerprint “B” is shown to be updated from “1” to “0” in row 412, attribute fingerprint column 404. The message re-classifier 214 of FIG. 2 may generate a new message score for the message M4, for example, through a process similar to the process described above in connection with the message M2. In the example case of M4, the message's current classification of spam and its updated classification of legit in row 320, current classification column 308 indicate that the initial classification of the message M4 was a false negative. Appropriate action may be taken on the message based on its change in classification.

It may be noted that the mail transfer agent interface 210 may be configured to notify the re-classifier 214 of FIG. 2 of false positive classifications and/or false negative classifications. For example, in some example embodiments, the re-classifier 214 may only re-classify the false positive case (e.g., when a message is inaccurately classified as legit).

Returning again to FIG. 5, at block 524, the example flow 500 may include a data re-evaluator providing a new evaluation of a message to a data delivery module.

In an example embodiment, the mail transfer agent 204 may first request, from the mail transfer agent interface 210, to receive a notification of a re-classified message. Once notified by the mail transfer interface 210 of a new classification (e.g., of the re-classified message), and responsive to the re-classifying of the message, the mail transfer agent 204 may direct (e.g., via transmission of a signal) the mail store interface 208 to communicate with the mail store 220 to initiate performance of an operation on the re-classified message in the mail store 220, in accordance with a message delivery policy.

At block 526, the example flow 500 may include a data delivery module applying a delivery policy to the message based on the new evaluation. In some example embodiments, the operation initiated by the mail transfer agent 204 selected based on how the message has been re-classified. When a message is re-classified as spam, the mail transfer agent 204 may direct the mail store interface 208 to initiate, for example, movement or deletion of the message in the mail store 220. In an example embodiment, the mail store interface 208 may include information with the call, such as message recipient information, the mail store 220 Internet protocol (IP) address, and the recipient's message handling policy to the mail store interface 208, which may initiate an action to be taken on the message by the mail store 220.

The mail store interface 208 may receive the interface call and transmit a signal to the mail store 220 causing re-classified messages to be acted upon based on a policy (e.g., a policy specific to a message recipient) for a particular spam score and corresponding classification. The mail store 220 may return a success, failure, and/or error message responsive to the signal.

In some example embodiments, signals to perform action on the message may be transmitted to a remote networked machine coupled to the mail store 220 to trigger the performance of the operation on the message in the mail store 220. Signals may alternatively or additionally be directed to a desktop mail program operating on a local machine to initiate the performance of the operation on the message in the mail store 220.

At block 528, the example flow 500 may include a data store performing an operation on the message according to the delivery policy. In the example embodiment where messages are scanned for changes in classification after the message has been delivered to the mail store 220 but before a recipient has seen the message, the mail store 220 may determine, in response to a call to act on a message, whether the message arrived more recently than the last time the user logged in. If so, then the mail store 220 (e.g., or a machine operating the mail store 220) may act on the message using a delivery policy provided in a call from the mail store interface 208. If the mail store 220 determines that the message did not arrive more recently than the last time the user logged in, then the mail store 220 may return an error code to the mail store interface 208. The mail store interface 208 may further provide a success or failure notification to the mail transfer agent 204 depending on whether or not action was successfully taken on the message.

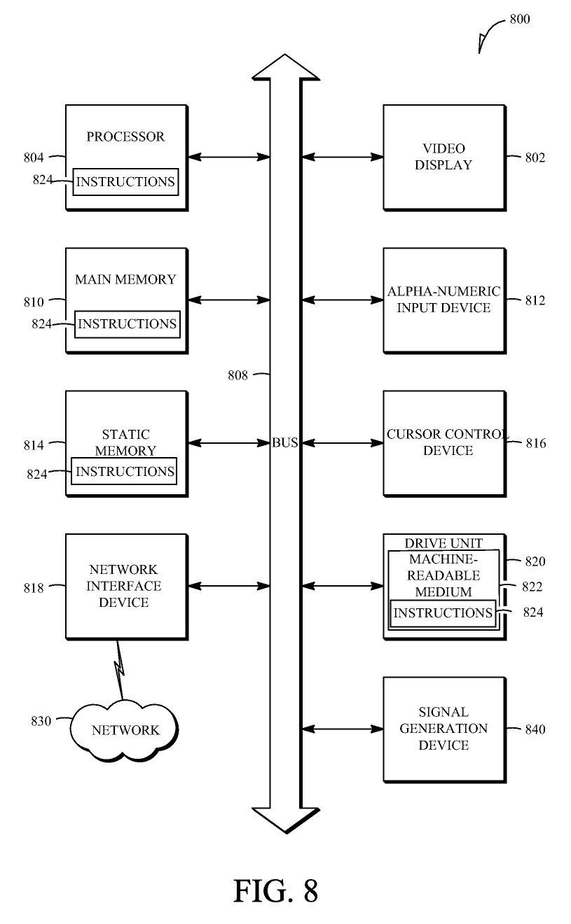

FIG. 8 shows a diagrammatic representation of a machine in the example form of a computer system 800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 804 (e.g., a central processing unit (CPU) a graphics processing unit (GPU) or both), a main memory 810 and a static memory 814, which communicate with each other via a bus 808. The computer system 800 may further include a video display unit 802 (e.g., a liquid crystal display (LCD) or a cathode ray tube (CRT)). The computer system 800 also includes an alphanumeric input device 812 (e.g., a keyboard), a cursor control device 816 (e.g., a mouse), a disk drive unit 820, a signal generation device 840 (e.g., a speaker) and a network interface device 818.

The disk drive unit 820 includes a machine-readable medium 822 on which is stored one or more sets of instructions (e.g., software 824) embodying any one or more of the methodologies or functions described herein. The software 824 may also reside, completely or at least partially, within the main memory 810 and/or within the processor 804 during execution thereof by the computer system 800, the main memory 810 and the processor 804 also constituting machine-readable media.

The software 824 may further be transmitted or received over a network 830 via the network interface device 818.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the claimed subject matter. The term “machine-readable medium” shall accordingly be taken to include, but not be limited to, solid-state memories, and optical and magnetic media.

Thus, a method and system to re-evaluate data have been described. Although the claimed subject matter has been described with reference to specific example embodiments, it will be evident that various modifications and changes may be made to these embodiments without departing from the broader spirit and scope of what is claimed. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
generating a representation of at least a portion of a message;
accessing a first characteristic associated with the representation;
classifying the message using the representation and the first characteristic;
initiating application of a policy rule to the message based on the classifying of the message;
accessing a second characteristic associated with the representation subsequent to the application of the first policy to the message;
re-classifying the message based on the representation and the second characteristic; and
initiating application of a further policy rule to the message, based on the re-classifying of the message.

2. The method of claim 1, further comprising:
causing the representation of at least the portion of the message to be stored; and
removing the stored representation from storage based on a removal parameter, wherein the re-classifying of the message includes re-classifying the message prior to the removing of the stored representation from the storage.

3. The method of claim 2, wherein the removal parameter comprises an interval of time and the removing of the stored representation includes removing the stored representation after the interval of time has expired.

4. The method of claim 1, wherein the re-classifying of the message based on the representation and the second characteristic comprises:
replacing the first characteristic with the second characteristic; and
determining that the replacing of the first characteristic changes the classification of the message.

5. The method of claim 1, wherein the re-classifying of the message includes determining that the second characteristic is associated with the representation.

6. The method of claim 5, wherein the generating of the representation of at least the portion of the message includes generating a hash value that represents the portion of the message, the portion of the message being an attribute of the message;
the second characteristic is received with the hash value; and
the determining that the second characteristic is associated with the representation includes accessing a data structure to determine that the hash value received with the second characteristic corresponds to the hash value that represents the portion of the message.

7. The method of claim 1, wherein the initiating of the application of the further policy rule to the message includes receiving a notification indicating a classification of the re-classified message, and selecting an operation associated with the policy rule to initiate, based on the reclassifying of the message.

8. The method of claim 1, wherein the initiating of the application of the further policy rule includes initiating storage of the message in a message store.

9. The method of claim 8, wherein the initiating of the application of the further policy rule includes initiating performance of an operation on the message in the message store.

10. The method of claim 1, wherein the initiating of the application of the further policy rule to the message includes transmitting, via a network, a signal to a networked machine coupled to a message store to initiate performance of an operation on the message in a message store.

11. The method of claim 10, wherein the signal to the networked machine comprises an interface call and the transmitting of the signal is to trigger the networked machine to at least one of move the message to a storage location in the message store and delete the message from the storage location in the message store.

12. The method of claim 1, wherein the initiating of the application of the further policy rule to the message includes issuing a signal to a local machine to initiate performance of an operation on a message in a message store.

13. The method of claim 12, wherein the issuing of the signal to the local machine is to trigger an application operating on the local machine to at least one of move the message to a storage location in the message store and delete the message from the storage location in the message store.

14. The method of claim 13, wherein the application operating on the local machine is a desktop mail program.

15. A system comprising:
a transfer agent, communicatively coupled to a message store, to process a message directed to the message store;
a message classifier communicatively coupled to the transfer agent, the message classifier to,
generate a representation of at least a portion of the message,
access a first characteristic associated with the representation, and
classify the message using the representation and the first characteristic; and
a message re-classifier communicatively coupled to the transfer agent, the message re-classifier to,
access a second characteristic associated with the representation subsequent to the delivery of the message to the message store, and
re-classify the message based on the representation and the second characteristic,
wherein the transfer agent is to initiate application of a policy rule to the message, based on the classification of the message, and to initiate application of a further policy rule to the message, based on the re-classification of the message,

16. The system of claim 15, further comprising:
a message tracker to cause the representation of at least the portion of the message to be stored in message storage; and
a message removal module to remove the stored representation from message storage based on a removal parameter, wherein the message re-classifier is to re-classify the message prior to the message removal module removing the stored representation.

17. The system of claim 16, wherein the removal parameter is associated with an interval of time, and the message removal module is to remove the stored representation upon an expiration of the interval of time.

18. The system of claim 15, wherein the message re-classifier is to replace the first characteristic with the second characteristic, and determine that the replacement of the first characteristic changes the classification of the message, and re-classify the message further based on that determination.

19. The system of claim 15, wherein the message re-classifier is to determine that the accessed second characteristic is associated with the representation, prior to re-classification of the message.

20. The system of claim 19, wherein the portion of the message includes an attribute of the message and the message classifier is to generate a hash value that represents the attribute of the message, and the message re-classifier is to receive the second characteristic with the hash value, and access storage to determine that the hash value included with the received second characteristic is the hash value that represents the portion of the message.

21. The system of claim 15, wherein the message re-classifier is to provide, to the transfer agent, a notification indicating a new classification of the re-classified message, and the transfer agent is to select an operation to initiate associated with the application of the further policy rule, based on the new classification.

22. The system of claim 15, wherein the transfer agent is to transmit, via a network, a signal directed to a networked machine coupled to a message store to initiate performance of an operation that is associated with application of the further policy rule, on the message in the message store.

23. The system of claim 22, wherein the signal to the networked machine provides an interface call to trigger the networked machine to at least one of move the message to a storage location in the message store and delete the message from the storage location in the message store.

24. The system of claim 15, wherein the transfer agent is to issue a signal directed to a local machine to initiate performance of an operation associated with application of the further policy rule on the message in a message store.

25. The system of claim 24, wherein the signal to the local machine is to cause an application operating on the local machine to at least one of move the message to a storage location in the message store and delete the message from the storage location in the message store.

26. The system of claim 25, wherein the application operating on the local machine is a desktop mail program.

27. A machine-readable medium including instructions that when executed by a machine, cause the machine to perform operations, the operations comprising:
receiving a message;
generating a representation of an attribute of the message;
accessing a first score associated with the representation;
classifying the message using the representation and the first score;
delivering the message to a message store, based on the classifying of the message;
processing a second score associated with the representation subsequent to the delivering of the message to the message store;
re-classifying the message based on the representation and the second score; and
initiating performance of an operation on the message in the message store, based on the re-classifying of the message.

28. The machine-readable medium of claim 27, wherein the re-classifying of the message based on the representation and the second score comprises:
replacing the first score with the second score; and
determining that the replacing of the first score changes the classification of the message.

29. The machine-readable medium of claim 27, wherein the re-classifying of the message includes determining that the received second score is associated with the representation.

30. The machine-readable medium of claim 27, wherein initiating the performance of the operation on the message includes transmitting, via a network, a signal to a networked machine coupled to a message store to initiate the performance of the operation on the message in the message store.

31. The machine-readable medium of claim 27, wherein initiating the performance of the operation includes issuing a signal to a local machine to initiate the performance of the operation on the message in the message store.

32. A system comprising:
generating means for generating a representation of at least a portion of the message;
first accessing means for accessing a first characteristic associated with the representation;
classifying means for classifying the message using the representation and the first characteristic;
first initiating means for initiating application of a policy rule to the message based on the classifying of the message;
second accessing means for accessing a second characteristic associated with the representation subsequent to the classifying of the message;
re-classifying means for re-classifying the message based on the representation and the second characteristic; and
second initiating means for initiating application of a policy rule to the message, based on the re-classifying of the message.
